(19) United States
(12) Patent Application Publication
(10) Pub. No.: US 2019/0316815 A1
(43) Pub. Date: Oct. 17, 2019

(54) ZEOLITE-WATER REFRIGERATION WITH GRAPHITE FOAM ENHANCEMENT

(71) Applicant: UT-Battelle, LLC, Oak Ridge, TN (US)

(72) Inventors: James William Klett, Knoxville, TN (US); Ryan K. Duncan, Knoxville, TN (US)

(21) Appl. No.: 16/381,394

(22) Filed: Apr. 11, 2019

Related U.S. Application Data
(60) Provisional application No. 62/656,582, filed on Apr. 12, 2018.

(51) Int. Cl. F25B 17/08; F25B 41/04; F25B 37/00

(52) U.S. Cl. CPC F25B 17/08; C04B 38/0067; F25B 37/00; F25B 41/04

(57) ABSTRACT

A refrigeration apparatus includes a refrigeration enclosure comprising outer walls defining a hermetic interior refrigeration chamber, and a porous thermally conductive foam insert within the chamber. A desiccant enclosure includes outer walls defining a hermetic interior desiccant chamber, and a desiccant within the desiccant chamber. A fluid conduit establishes a fluid connection between the refrigeration chamber and the desiccant chamber. A control valve controls the flow of a fluid through the fluid conduit. The refrigeration enclosure and an article to be refrigerated can be placed within an outer thermally insulated cooler. A method of refrigerating an article and a human-powered refrigeration system are also disclosed.

### CROSS-REFERENCE TO RELATED APPLICATIONS

This application claims priority to U.S. Provisional Application No. 62/656,582 filed on Apr. 12, 2018, entitled “Zeolite-Water Refrigeration with Graphite Foam Enhancement”, the entire disclosure of which incorporated herein by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in this invention.

### FIELD OF THE INVENTION

The present invention relates to apparatus and methods for maintaining articles at reduced temperatures for extended periods of time without the use of electricity.

### BACKGROUND OF THE INVENTION

It is known that some vaccines are sensitive to heat and will become less effective or completely ineffective if not kept refrigerated or frozen. The U.S. Department of Health and Human Services, Centers for Disease Control and Prevention suggests refrigerated vaccines be maintained at temperatures between 2° C. and 8° C. (35° F. and 46° F.) and frozen vaccines be maintained at temperatures between −50° C. and −15° C. (−58° F. and 5° F.). The suggested ranges of temperatures are difficult or impossible to maintain for extended periods of time without adequate refrigeration systems and dependable electricity distribution.

An apparatus for maintaining articles at below ambient temperature is shown in U.S. Pat. No. 9,933,206 issued Apr. 3, 2018, the disclosure of which is incorporated herein fully by reference. Disclosed therein is an apparatus and method for maintaining articles, such as vaccines, transplant organs or food, within their recommended temperature ranges for extended periods of time and without the need for grid-supplied electricity. An enclosure has an interior chamber into which a porous graphite foam material is placed. Water or another liquid in the enclosure is wicked into the porous graphite foam. A vacuum pump is activated to reduce the pressure of a volume of sealed air within the interior chamber to a pressure that is below the vapor pressure of the liquid, whereupon the liquid will evaporate and the heat of vaporization will lower the temperature of the graphite and the article in the enclosure. The vacuum pump is operated each time the temperature within the enclosure is lowered.

Graphitic foams are carbon-based materials with high thermal conductivity, good porosity, and are light in weight. Graphite foam articles and methods for manufacturing graphite foams are described in U.S. Pat. No. 6,033,506 “PROCESS FOR MAKING CARBON FOAM”; U.S. Pat. No. 6,037,032 “PITCH-BASED CARBON FOAM HEAT SINK WITH PHASE CHANGE MATERIAL”; U.S. Pat. No. 6,261,485 “PITCH BASED CARBON FOAM AND COMPOSITES”; U.S. Pat. No. 6,287,375 “PITCH BASED FOAM WITH PARTICULATE”; U.S. Pat. No. 6,344,159 “METHOD FOR EXTRUDING PITCH BASED FOAM”; U.S. Pat. No. 6,387,343 “PITCH-BASED CARBON FOAM AND COMPOSITES”; U.S. Pat. No. 6,398,994 “METHOD OF CASTING PITCH BASED FOAM”; U.S. Pat. No. 6,399,149 “PITCH-BASED CARBON FOAM HEAT SINK WITH PHASE CHANGE MATERIAL”; U.S. Pat. No. 6,491,891 “GELCASTING POLYMERIC PRECURSORS FOR PRODUCING NET-SHAPED GRAPHITES”; U.S. Pat. No. 6,656,443 “PITCH BASED CARBON FOAM AND COMPOSITES”; U.S. Pat. No. 6,673,328 “PITCH BASED CARBON FOAM AND COMPOSITES AND USES THEREOF”; U.S. Pat. No. 6,780,505 “PITCH-BASED CARBON FOAM HEAT SINK WITH PHASE CHANGE MATERIAL”; U.S. Pat. No. 6,855,744 “GELCASTING POLYMERIC PRECURSORS FOR PRODUCING NET-SHAPED GRAPHITES”; U.S. Pat. No. 7,070,755 “PITCH-BASED CARBON FOAM AND COMPOSITES AND USE THEREOF”; U.S. Pat. No. 7,456,131 “INCREASED THERMAL CONDUCTIVITY MONOLITHIC ZEOLITE STRUCTURES”; and U.S. Pat. No. 7,670,682 “METHOD AND APPARATUS FOR PRODUCING A CARBON BASED FOAM ARTICLE HAVING A DESIRED THERMAL-CONDUCTIVITY GRADIENT”, which are each herein incorporated by reference as if included at length. Graphite foam materials are commercially available from Poco Graphite, Inc., 300 Old Greenwood Road, Decatur, Tex. 76234, and Koppers, LLC, 436 Seventh Avenue, Pittsburgh, Pa. 15219-1800.

### SUMMARY OF THE INVENTION

A refrigeration apparatus includes a refrigeration enclosure having outer walls defining a hermetic interior refrigeration chamber and a porous graphitic foam insert within the chamber. A desiccant enclosure includes outer walls defining a hermetic interior desiccant chamber, and a desiccant within the desiccant chamber. A fluid conduit makes a fluid connection between the refrigeration chamber and the desiccant chamber. A control valve is provided for controlling the flow of a fluid through the fluid conduit. The refrigeration apparatus can further include an insulated outer cooler for receiving the refrigeration enclosure and the article.

The porous thermally conductive foam insert can include at least one selected from the group consisting of graphitic foam, aluminum foam and copper foam. A graphitic foam can have a thermal conductivity of from 50 W/mK to 245 W/mK. The graphitic foam can have a density of from 0.38 g/cm³ to 0.93 g/cm³.

The desiccant can be a zeolite. The desiccant can be activated carbon. Other desiccants are possible.

The refrigeration apparatus can include a liquid in the refrigeration chamber, or the liquid can be added at the time of use. The liquid can be water, but other liquids are possible. Gas in the desiccant enclosure and/or the refrigeration enclosure can be air. Other gases are possible.

The porous thermally conductive foam insert can define an interior space for receiving an article to be refrigerated. The interior space can be customized for the particular article, such that the foam is in close contact with the article.

In an initial state there is liquid in the refrigeration chamber. The desiccant chamber is evacuated to a pressure less than the surrounding ambient air pressure and less than the refrigeration chamber, and the control valve is in a closed position. The control valve can be operated to effect cooling of the refrigeration chamber and the article.

The refrigeration enclosure can include thermal insulation. The thermal insulation can be at least one selected from the group consisting of double walls, ceramic microspheres, and insulating polymeric materials.

A temperature sensor can be provided for sensing a temperature somewhere or at multiple locations within the refrigeration apparatus, such as in the refrigeration enclosure or a surface of the article. An actuator for operating the control valve. The temperature sensor can generate a control signal, and the actuator can operate the control valve responsive to the control signal.

A vacuum pump can be provided to evacuate gas from the desiccant chamber. The vacuum pump can be a manually operated vacuum pump, such that the refrigeration apparatus can be recharged where there is no electrical power. The air pressure within the refrigeration chamber can vary. The sealed gas pressure within the refrigeration chamber can be maintained at between approximately 5.2 torr (mmHg) and 8.0 torr (mmHg). A vacuum pressure gauge can penetrate the enclosure for monitoring and displaying the pressure of the sealed gas in the interior chamber.

A purge valve can be provided in at least one selected from the group consisting of the refrigeration enclosure and the desiccant enclosure. The refrigeration enclosure can include a closeable opening providing access to the refrigeration chamber. The purge valve can be provided in the closeable opening

The dessicant enclosure can include a closeable opening. A purge valve can be provided in the closeable opening. The closeable opening can also be used to provide access by a vacuum pump.

A method of refrigerating an article according to the invention includes the step of providing a refrigeration apparatus that includes a refrigeration enclosure comprising outer walls defining a hermetic interior refrigeration chamber, and a porous thermally conductive foam insert within the chamber. A desiccant enclosure includes outer walls defining a hermetic interior desiccant chamber, and a desiccant within the desiccant chamber. A fluid conduit makes a fluid connection between the first chamber and the second chamber. A control valve is provided for controlling the flow of fluid through the fluid conduit. An article to be refrigerated is placed in proximity to the refrigeration chamber, and with the control valve in the closed position. A liquid is placed in the refrigeration chamber and the liquid enters the pores of the thermally conductive porous foam insert. Gas is evacuated from the desiccant chamber to a pressure below the vapor pressure of the liquid in the refrigeration chamber. The control valve is opened to permit the liquid to vaporize in the refrigeration chamber and to flow from the refrigeration chamber to the desiccant chamber, the heat of vaporization cooling the porous thermally conductive foam insert and the article in proximity to the refrigeration enclosure.

The method can further include the step of placing the refrigeration enclosure and the article within an outer thermally insulated cooler. The liquid can be water. The method of can include the step of desorbing the liquid from the desiccant by heating and cooling the desiccant. The method can include the step of purging gas from the desiccant chamber until the pressure in the desiccant chamber is below the vapor pressure of the liquid. The pressure in the desiccant chamber after purging can be 1-50 millitorr. The method can also include the step of purging gases from the refrigeration chamber.

The porous foam can define an interior space for receiving an article to be refrigerated. The method can include the step of placing the article in the interior space of the porous thermally conductive foam insert.

A temperature within the refrigeration apparatus can be sensed. The method can include the step of operating the control valve responsive to the sensing of temperature. A temperature signal can be generated from the sensed temperature, and an actuator for the control valve can be operated responsive to the sensed temperature. The method can include the step of monitoring a vacuum pressure within the refrigeration chamber, and operating the control valve responsive to the vacuum pressure.

A human-powered refrigeration system can include a refrigeration enclosure comprising outer walls defining a hermetic interior refrigeration chamber, and a porous thermally conductive foam insert within the chamber. A desiccant enclosure has outer walls defining a hermetic interior desiccant chamber, and a desiccant within the desiccant chamber. A fluid conduit makes a fluid connection between the first chamber and the second chamber. A control valve is provided for controlling the flow of fluid through the fluid conduit. A manual vacuum pump is provided for reducing the pressure of sealed air within the desiccant chamber. The temperature of the thermally conductive porous foam insert is maintained at a temperature that is less than the temperature of the ambient air outside of the enclosure when a human activates the manual vacuum pump to reduce the pressure of the volume of sealed air within the desiccant chamber to a pressure that is below the vapor pressure of the liquid.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic depiction of a refrigeration apparatus with a desiccant enclosure and a refrigeration enclosure;

FIG. 2 is a schematic depiction of the refrigeration apparatus of FIG. 1, with a graphitic foam insert;

FIG. 3 is flow diagram illustrating a method of the invention;

FIG. 4 is a simplified cross sectional view of an exemplary refrigeration enclosure and graphitic foam insert;

FIG. 5 is an exploded view of another exemplary refrigeration enclosure;

FIG. 6 is a simplified cross sectional view of another exemplary refrigeration enclosure;

FIG. 7 is an exploded view of an exemplary insert with other features removed for clarity;

FIG. 8 is an exploded view of another exemplary insert with other features removed for clarity;

FIG. 9 is a photomicrograph of a porous, graphite foam material of the type used in the exemplary inserts; and,

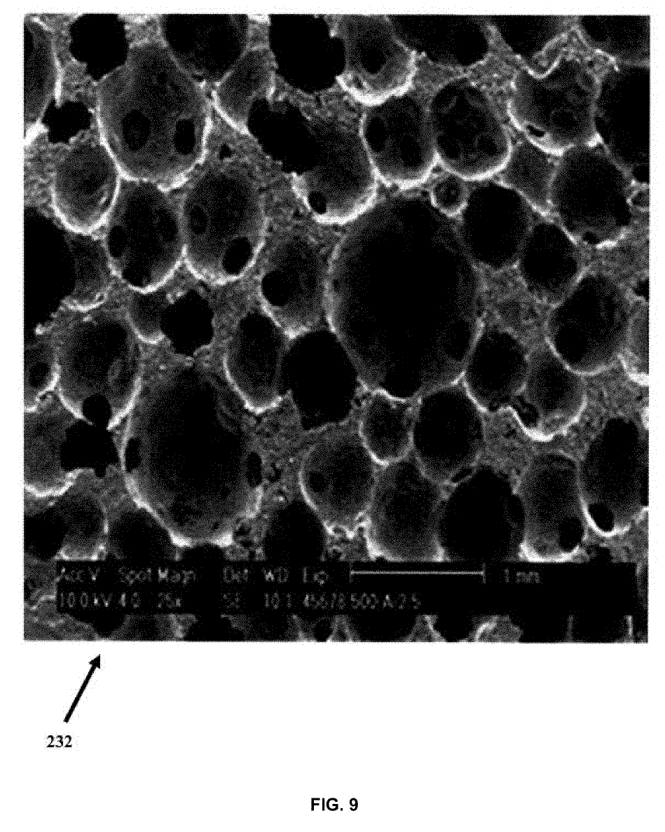

FIG. 10 is a plot of temperature (° C.) vs. time (min) for an article within refrigeration apparatus, the inside wall of the refrigeration apparatus, and the inside atmosphere of the refrigeration apparatus.

### DETAILED DESCRIPTION OF THE INVENTION

A refrigeration apparatus includes a refrigeration enclosure comprising outer walls defining a first hermetic interior refrigeration chamber. A closure provides access to the chamber. A purge valve or closeable purge opening can be provided to evacuate air from the refrigeration enclosure. A porous thermally conductive foam insert can be provided within the refrigeration chamber.

A desiccant enclosure includes outer walls defining a second hermetic interior desiccant chamber. A purge valve or closeable opening can be provided for evacuation of gas from the desiccant chamber. A desiccant is provided within the desiccant chamber.

A desiccant will absorb water from the vapor space and preserve a low pressure around the desiccant. The desiccant can be any suitable desiccant material. The desiccant can be a zeolite. The desiccant can be activated carbon. Other desiccants are possible. The desiccant can be mixtures of desiccant materials.

A fluid conduit establishes a fluid connection between the refrigeration chamber and the desiccant chamber. A control valve is provided for controlling the flow of a fluid through the fluid conduit. The fluid conduit and control valve allow vapor from the refrigeration chamber to be removed to the desiccant chamber upon demand, and can be used to control the temperature within the refrigeration chamber.

The refrigeration enclosure can be made large enough to place the article directly inside the refrigeration enclosure. Alternatively, the refrigeration enclosure can be placed within a larger outer insulated cooler that is dimensioned to hold both the refrigeration enclosure and the article to be refrigerated. A port can be proved in the cooler to permit passage of the fluid conduit from the refrigeration enclosure to the desiccant enclosure.

Graphite foam is a structure having highly ordered graphitic ligaments, is dimensionally stable, has open porosity, and has excellent thermal management capability. The graphitic foam insert can define an interior space for receiving an article to be refrigerated. The shape and size of the graphitic foam insert can be varied. The interior space can be specifically designed to receive an article of a particular size and shape, or can be of a more general size to receive articles of differing sizes and shapes. It is preferable that the article be in contact with the insert to permit maximum heat transfer by conduction, but articles will be cooled even if there is not complete contact. The graphitic foam can have a thermal conductivity of from 50 W/mK to 245 W/mK. The graphitic foam can have a density of from 0.38 g/cm³ to 0.93 g/cm³. Metal foams such as aluminum foams and copper foams are also porous and thermally conductive and can be used.

The article must be placed in ‘proximity’ to the graphitic foam. Proximity as used herein means that the article is spaced from, touching or enveloped by the foam sufficiently that heat transfer occurs between the foam and the article. This heat transfer can thereby be conduction or convection or some combination of both. The article can be placed either directly within the refrigeration enclosure in proximity to the graphitic foam, or the article can be placed within an outer insulated cooler, and the refrigeration enclosure is also placed in the cooler. The article would then be in proximity to the outer walls of the refrigeration enclosure.

The refrigeration enclosure and/or the outer insulated cooler can be insulated by a number of insulating materials or constructions. If the refrigeration enclosure and the article are to be placed within an outer cooler that is thermally insulated, then the refrigeration enclosure should not be thermally insulated, so that heat transfer between the refrigeration enclosure and the article is facilitated. In one aspect, the thermally insulated enclosure is double walled, such as in a liquid nitrogen dewar. Alternative insulating structure is possible. The outer walls can be made from or can include insulating polymeric materials having low thermal conductivity and superior formability such as polypropylene, polyethylene, nylon, polyester, polystyrene, polyurethane, polyvinylchloride or other materials having similar properties. Conventional thermoplastic manufacturing processes such as injection molding, blow molding or 3D printing may be used to form the outer walls. The outer walls may include a core portion filled with an insulating material such as polyurethane foam, expanded polystyrene foam, and/or engineered ceramic or glass microbeads or microspheres. Microspheres made of soda-lime-borosilicate glass having densities and particle sizes of (0.125 g/cc to 0.60 g/cc) and (65 microns to 16 microns) respectively are available from 3M Energy and Advanced Materials Division for example. In other examples, microspheres can be mixed with polyurethane foam in various ratios can be used to form the core.

The refrigeration apparatus can include a temperature sensor for sensing a temperature of the refrigeration enclosure or within the refrigeration chamber, the temperature of the article, or the temperature within an outer insulated cooler. An actuator can be provided for operating the control valve. The temperature sensor generates a control signal, and the actuator which can be separate or an integrated part of the control valve operates the control valve responsive to the control signal.

Air will usually be the gas in the enclosure. Other gases are possible. Some applications may require an inert gas (nitrogen) to delay spoilage, or for food, organ transplants and the like. Water can be used as the liquid. Other liquids will work similarly and are also contemplated. Nontoxic and nonflammable liquids are preferred.

The amount of liquid that is added to the refrigeration chamber can vary. In some examples, the volume of liquid added is up to 50% of the pore volume of the graphite foam insert. In another example, the volume of liquid added is up to 75% of the pore volume of the graphite foam insert. In another example, the volume of liquid added is up to 100% of the pore volume of the graphite foam insert. In other examples, the volume of liquid added is greater than 100% of the pore volume of the graphite foam insert.

A method of refrigerating an article can include the steps of providing a refrigeration apparatus with a refrigeration enclosure comprising outer walls defining a hermetic interior refrigeration chamber, a closure providing access to the chamber, and a porous graphitic foam insert within the chamber. A desiccant enclosure can include outer walls defining a hermetic interior desiccant chamber, and a desiccant within the desiccant chamber. A fluid conduit established a fluid connection between the refrigeration chamber and the desiccant chamber, and a control valve for controls the flow of fluid through the fluid conduit. An article to be refrigerated is placed in the refrigeration chamber, and in proximity to the graphitic foam insert, or within an outer thermally insulated cooler into which both the article and the refrigeration enclosure are placed. The control valve should be in the closed position. Water or another liquid is placed in the refrigeration chamber. The liquid wicks into the pores of the insert, such as the porous graphitic foam.

The refrigeration apparatus can have an initial state where there is water or another liquid in the refrigeration chamber. The desiccant chamber is evacuated to a pressure less than the surrounding ambient air pressure and less than the refrigeration chamber. The control valve is in a closed position.

Gas is evacuated from the desiccant chamber to a pressure below the vapor pressure of the liquid such as water in the refrigeration chamber. The control valve is opened to permit water to vaporize in the refrigeration chamber and to flow from the refrigeration chamber to the lower pressure desiccant chamber. Water in the refrigeration chamber will evaporate as the pressure in the refrigeration chamber decreases because of the escaping vapors, and the heat of vaporization of the water cools the graphitic foam and the article in proximity to the graphitic foam.

The pressure (vacuum) that must be created in the desiccant chamber will vary with the construction of the apparatus, the desiccant, the graphitic foam, the liquid, the gas in each chamber and the duration over which refrigeration is desired. The pressure within the refrigeration chamber similarly can vary. The pressure in the desiccant chamber after purging can be from 1-50 millitorr. The pressure in the refrigeration chamber will also vary, and particularly with the constitution of the gas and the liquid. For example, if the gas is air and the liquid is water the pressure within the refrigeration chamber can be maintained at a pressure that is between 5.2 torr (mmHg) and 8.0 torr (mmHg).

The method can further comprise the step of desorbing water from the desiccant by heating and cooling the desiccant by alternately opening and closing the control valve. This will usually be a first step to insure that the desiccant is as free of liquid as possible before using the device. The method can include the step of purging permanent gases from the refrigeration chamber.

The method can include the step of sensing a temperature within the refrigeration chamber of the refrigerated enclosure, the temperature of the article, or the temperature within an outer insulated cooler into which the refrigeration enclosure and the article have been placed. The method can further include the step of operating the control valve responsive to the sensing of temperature. The method can include the step of generating a temperature signal from the sensed temperature and operating an actuator for the control valve responsive to the sensed temperature. The method can include the step of sensing pressure in one or both of the chambers, and operating the control valve responsive to the sensed pressure.

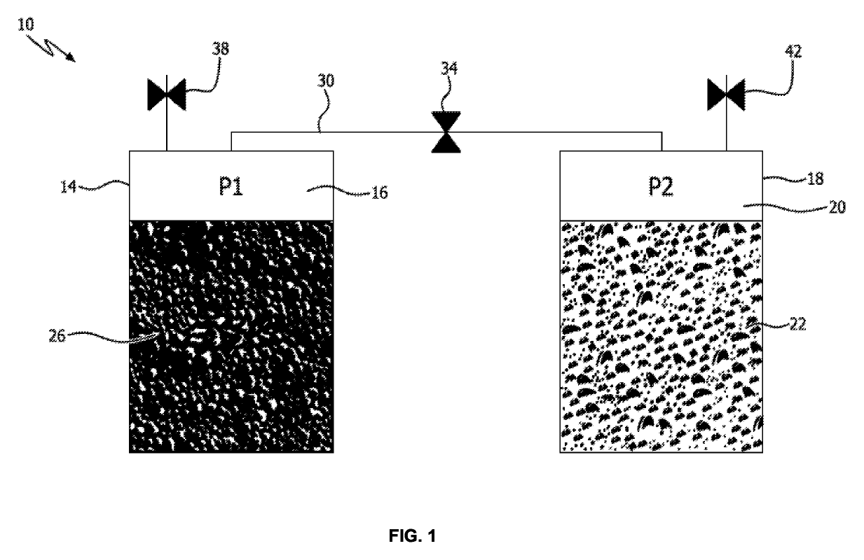

There is shown in FIG. 1 a system with a desiccant enclosure 14 and refrigeration enclosure 18. The desiccant enclosure has an open interior desiccant chamber 16. The refrigeration enclosure 18 has an open interior refrigeration chamber 20. A desiccant 26 like a zeolite or activated carbon that absorbs water. A graphite foam 22 at least partially filled with a liquid such as water is placed in the refrigeration chamber 20. The desiccant chamber 16 can be purged of permanent gases as by purge valve 38 that do not condense on the desiccant and the desiccant 26 can be desorbed by heating and then cooling steps. The pressure P1 in the desiccant chamber 16 will be very low, around 1-50 millitorr. This pressure is well below the vapor pressure of water, even at its freezing point of around 4 torr. The desiccant chamber 16 is fluidly connected to the refrigeration chamber 20 by a fluid conduit 30 with a control valve 34.

The refrigeration chamber 20 with the graphitic foam and water 22 can be purged of all permanent gases as by purge valve 42 to a pressure P2. This purge of the refrigeration chamber 20 can be accomplished by pulling hard vacuum and inserting water that has been de-aired of any dissolved gases. Another method is to boil the water in the refrigeration chamber and allow the steam to escape thus carrying the permanent gases with it. The refrigeration chamber can be closed and allowed to cool. The refrigeration chamber 20 will then be at the vapor pressure of the water and at the ambient temperature that it has attained equilibrium with.

When the control valve 34 between the two chambers is opened, the high vacuum in the desiccant chamber P1 will cause the water 22 in the refrigeration chamber 20 which is at P2 to evaporate and possibly boil. This will cause a lowering of the temperature in the refrigeration chamber 20. As the water vapor moves to the desiccant chamber 16, the water vapor condenses in the desiccant 26 and the pressure in the desiccant chamber 16 remains very low, and significantly below the vapor pressure of the water in the refrigeration chamber 20. Thus, this effect can be controlled by opening and closing the valve between the two chambers. In some examples, the valve may be modulated to a position between the open and closed positions.

One effect of this evaporation and removal of water vapor is that the refrigeration chamber 20 will cool down and even freeze with the latent heat of the water causing the removal of energy from the refrigeration chamber 20. Thus, this system can be used to create a cooling effect by controlling the valve with respect to the temperature in the refrigeration chamber 20.

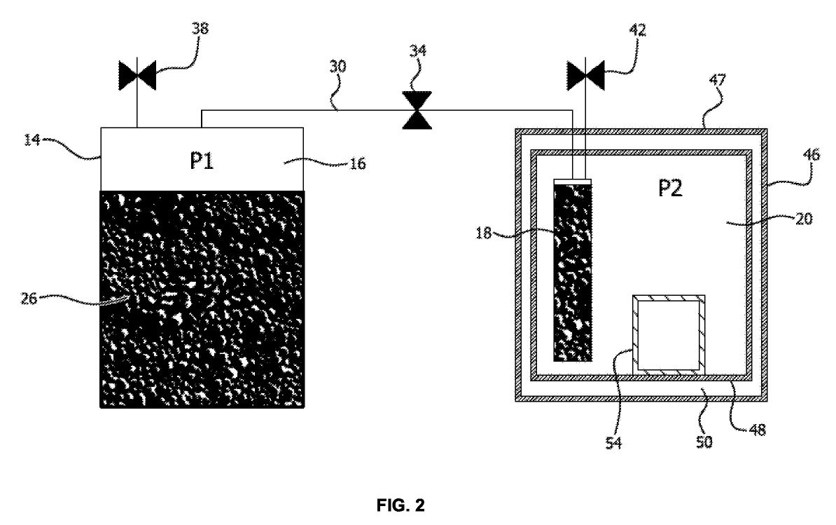

There is shown in FIG. 2 an embodiment in which the refrigeration enclosure 18 is placed within an outer insulated cooler 46, as through a removable top 47. The outer cooler 46 can be specially designed for this purpose, or can be a commercially available cooler such as expanded polystyrene coolers. The refrigeration enclosure can be placed within coolers of varying shapes, sizes, and constructions. The outer insulated cooler 46 can have an inner wall 48 defining an insulating vacuum space 50 to provide insulation. Alternatively the cooler 46 can be made of an insulating material such as an expanded polystyrene foam, or have another suitable insulating construction.

The enclosed refrigeration enclosure 18 is filled with a very high thermal conductivity graphite foam and a liquid such as water. The article 54 to be cooled can be placed in the cooler 46 in proximity to the refrigeration enclosure 18. Upon operation of the control valve 34, water vapor will be removed from the refrigeration chamber 20 and will cool the walls of the refrigeration enclosure 18 and thereby the interior of the cooler 46 and the article 54. If the insulation system is well designed, the rate of heat added to the cooler 46 and the refrigeration enclosure 18 will be very low, and the system can be chilled by opening the control valve 34 for a short period of time, and then when the temperature within the refrigeration chamber 20 reaches the desired temperatures, for example 4° C., the valve can be closed manually or automatically. The refrigeration chamber 20 within the refrigeration enclosure 18 may warm by only a few degrees Celsius over a significant amount of time. If this time frame is sufficiently long, such as 1 hour to rise 2° C., the system will be an effective cooler for many hours.

The system can be cycled. For example the control valve 34 can be opened to chill the refrigeration chamber 20 to 4° C. Then the control valve 34 is closed. Over time the temperature will rise, for example to 6° C. Then the control valve 34 is opened again for a few minutes to cool the refrigeration chamber down to 4° C. again. This can be performed automatically, and the refrigeration apparatus of the invention can operate for days, if not weeks without the need for electric power.

By filling the refrigeration chamber 20 with a high conductivity graphite foam insert and water, the effect of the latent heat can be very effective at rapidly cooling the entire refrigeration enclosure 18 and the article. Thus this provides a real time chilling effect. Without the graphite foam, the time lapse from the energy leaving the water and leaving the refrigeration chamber 20 is too long for an efficient cooling effect to be felt.

The cooling effect can be calculated for the total duration based on the time it takes between cycles. This is related to how much water is pulled from the refrigeration chamber 20 to the desiccant chamber 16 in that cycle while the control valve 34 is open.

The vapor pressure of a liquid is defined as the equilibrium pressure of a vapor above the liquid level in a sealed space. When equilibrium is reached, the number of molecules of liquid evaporating equals the number of vapor molecules condensing. By reducing the pressure inside the sealed space, the molecules of liquid have a greater tendency to evaporate to form water vapor. Under a vacuum, liquids boil at a much lower temperature than at atmospheric pressure. Without increasing the temperature, energy for boiling comes from the liquid itself and, consequently, the temperature of the liquid is reduced and the liquid freezes. Table 1 is listing the vapor pressure of water at temperatures between 0° C. and 20° C.

TABLE 1
Vapor Pressures of Water (H₂O) at Temperatures
between 0° C. and 20° C.

| Temperature | | | Pressure ⁽³⁰⁾ | | | | |
|---|---|---|---|---|---|---|---|
| ° C. | K | ° F. | Pa | atm | torr(mmHg) | in Hg | psi |
| 0 | 273 | 32 | 611 | 0.00603 | 4.58 | 0.180 | 0.0886 |
| 5 | 278 | 41 | 872 | 0.00861 | 6.54 | 0.257 | 0.1265 |
| 10 | 283 | 50 | 1,228 | 0.01212 | 9.21 | 0.363 | 0.1781 |
| 12 | 285 | 54 | 1,403 | 0.01385 | 10.52 | 0.414 | 0.2034 |
| 14 | 287 | 57 | 1,599 | 0.01578 | 11.99 | 0.472 | 0.2318 |
| 16 | 289 | 61 | 1,817 | 0.01793 | 13.63 | 0.537 | 0.2636 |
| 17 | 290 | 63 | 1,937 | 0.01912 | 14.53 | 0.572 | 0.2810 |
| 18 | 291 | 64 | 2,064 | 0.02037 | 15.48 | 0.609 | 0.2993 |
| 19 | 292 | 66 | 2,197 | 0.02168 | 16.48 | 0.649 | 0.3187 |
| 20 | 293 | 68 | 2,338 | 0.02307 | 17.54 | 0.691 | 0.3392 |

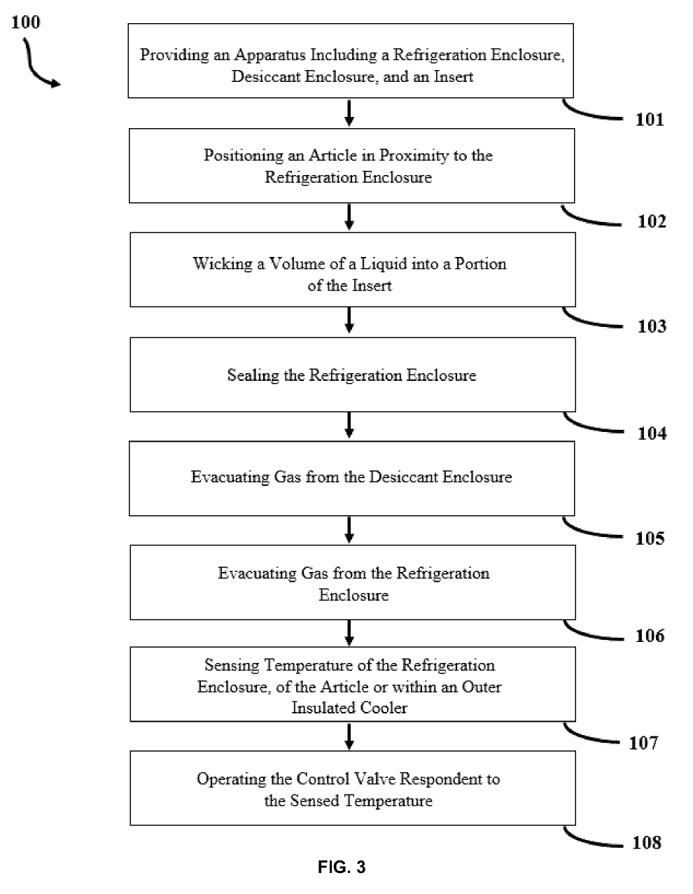

FIG. 3 illustrates a method 100 for maintaining an article at a temperature that is below the ambient air temperature. In a first step represented by block 101, an apparatus including a refrigeration enclosure, a desiccant enclosure, and an insert is provided. In a second step represented by block 102, an article is positioned in proximity to the insert, which can be either within the refrigeration enclosure. In a third step represented by block 103, a volume of a liquid is wicked into the graphite foam insert. In a fourth step represented by block 104, the enclosure is hermetically sealed. In a fifth step represented by block 105, gas is evacuated from the desiccant enclosure. In a sixth step represented by block 106, gas is evacuated from the refrigeration enclosure. In a step represented by block 107, a temperature of the refrigeration enclosure, the article, or within an outer insulated cooler is sensed. In a final step represented by block 108, the control valve is operated responsive to the sensed temperature. Other method steps are possible.

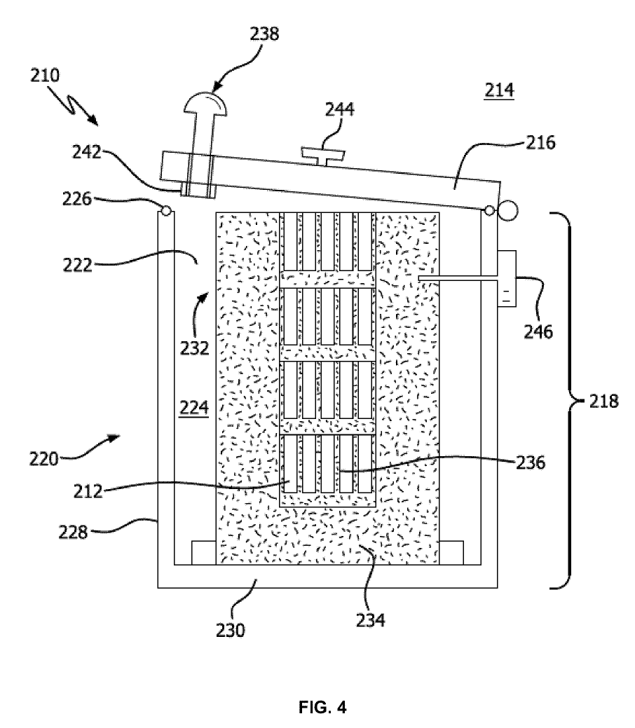

With reference first to FIGS. 4-8, various features of an apparatus 210 for maintaining the temperature of an article 212 at a temperature that is below an ambient air 214 temperature are shown. It is to be understood that the ambient air 214 is outside of the apparatus 210. These are embodiments in which the article to be cooled is placed directly within the refrigeration enclosure. The article can alternatively be placed in a cooler, and the refrigeration enclosure can also be placed within the cooler. A lid 216 attaches to a body 218 to form an enclosure 220 which defines an interior chamber 222 for storing a volume of sealed air 224. In some examples, the lid 216 is affixed to the body 218 with a hinge, strap, clasp, clamp, latch, elastic lanyard or other attachment device. In other examples, the lid 216 includes threads that engage with complimentary threads on or in the body 218. In other examples, an O-ring or gasket 226 may be disposed between mating surfaces of the lid 216 and the body 218. When assembled together, the lid 216, body 218 and gasket 226 cooperate to form a hermetic seal. Note that in the example of FIG. 4, the hermetic seal may be at least partially maintained when the article 212 is accessed through a separate access port. The enclosure 220 may be cylindrical, square, rectangular or otherwise shaped.

The body 218 includes an outer wall 228 that insulates the interior chamber 222 from the external environment and specifically, the ambient air temperature. The outer wall 228 may include a core portion 230 filled with an insulating material such as polyurethane foam and/or engineered ceramic or glass microbeads or microspheres.

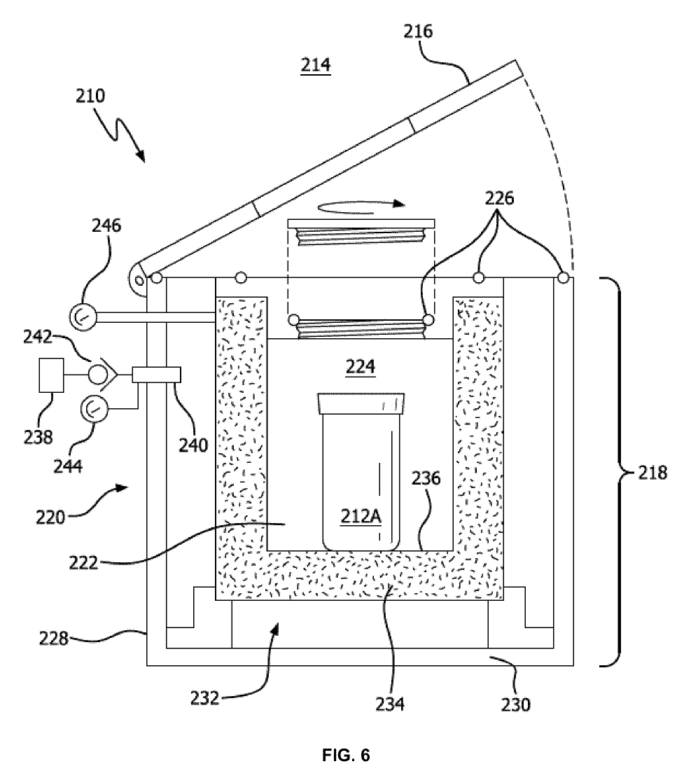

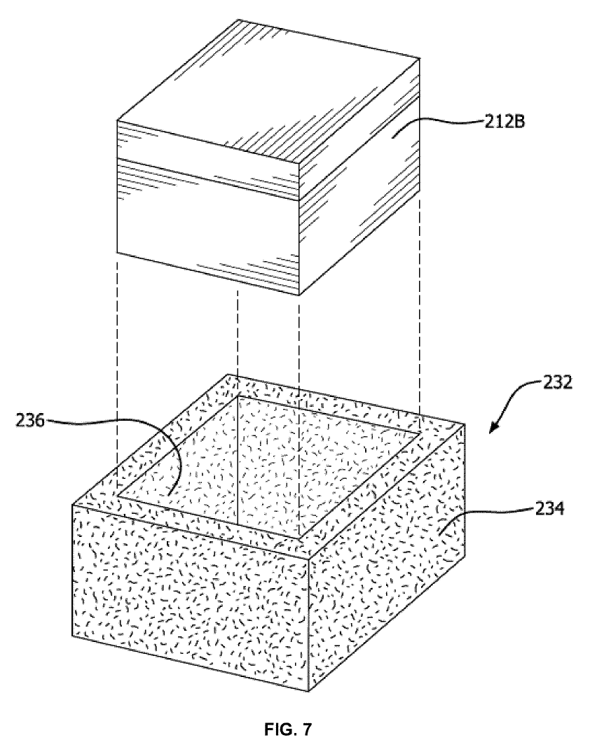

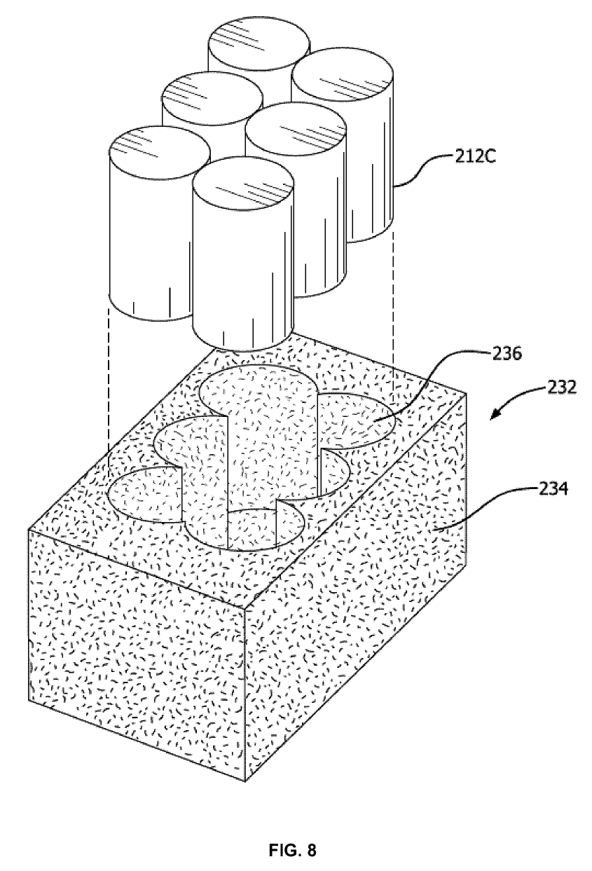

Disposed within a portion of the interior chamber 222 is an insert 232 having a body 234 that includes a region 236 for contacting an article 212. Preferably, the region 236 fully contacts (e.g., surrounds), or at least partially contacts the article 212 for increased thermal conduction. In some examples, one or more inserts 232 include regions 236 that are sized and shaped to accommodate specific articles 212 such as vaccine ampules 212A (FIG. 6), containers 212B for transplant organs or containers for other articles including foods (FIG. 7) or containers 212C for beverage containers or other multi cylinder articles (FIG. 8). In other examples, inserts 232, include contact regions 236 that are shaped specifically for food articles 212 such as fish, meat or poultry.

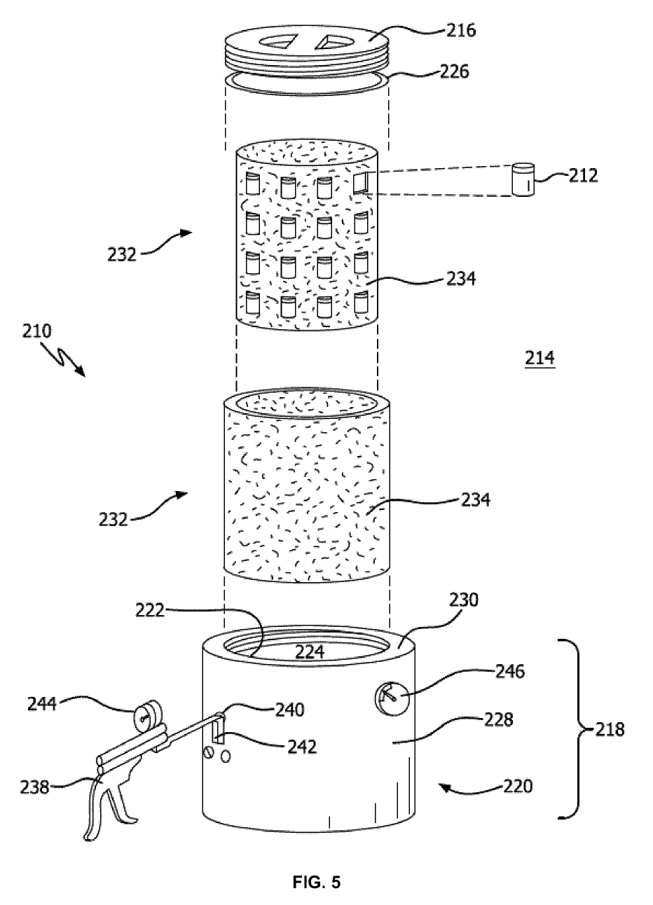

The evacuation of the refrigeration chamber is illustrated in FIGS. 5-6. A vacuum pump 238 penetrates through the enclosure 220 and fluidly connects the sealed air 224 in the interior chamber 222 with the ambient air 214 outside of the enclosure 220. The vacuum pump 238 includes a one-way check valve and evacuates the sealed air 224 to the ambient air 214, which lowers the pressure of the sealed air 224. The vacuum pump 238 may be electrically powered, air powered, or preferably, manually powered by a human. In one example, a manual vacuum pump 238 attaches to a barbed fitting 240 that penetrates the enclosure 220. A valve 242 between the interior chamber 222 and the vacuum pump 238 can be closed to maintain the reduced pressure of the sealed air 224. The valve 242 may subsequently be opened to normalize the pressure between the sealed air 224 and the ambient air 214 prior to opening the lid 216. A vacuum pressure gauge 244 may be used to indicate the pressure of the sealed air 224 and to monitor for gasket 226 leakage.

A temperature gauge 246 may also penetrate the enclosure 220 for monitoring the temperature of the insert 232 and the article 212. A sensing element or probe contacts the insert 232 and an indicating element or dial is disposed and viewable outside of the enclosure 220. In some examples, the temperature gauge 246 is a thermometer using liquid expansion as an indication of temperature. In other examples, the temperature gauge 246 is a thermocouple that uses measured voltage as an indication of temperature. In one example, a battery or photovoltaic cell provides the necessary voltage to power the thermocouple and its display. In another example, the pumping action of the vacuum pump 238 or a separate crank charges a capacitor or rechargeable battery to power the thermocouple and display. In other examples, a temperature data memory and alarm are connected to the thermocouple circuit to provide temperature audit and alert capabilities. All penetrations through the enclosure 220 are hermetically sealed with a gasket and/or a sealant.

An example system was tested. A prototype system was produced which utilized standard insulation to create the effect of the insulation effect of a dewar. The desiccant chamber was filled with Zeolite and measured. The zeolite mass was 1854 grams. The refrigeration chamber within the refrigeration enclosure was filled with foam, and welded closed, and attached to the desiccant chamber by welding the tube to the refrigeration chamber. This refrigeration enclosure was insulated by positioning within an outer insulated cooler. 250 grams of de-aired water was added to the refrigeration chamber after vacuum was pulled. The desiccant chamber was heated to 250° C. and vacuum was applied. After 1 hour, the purge valve was closed, and then the desiccant chamber was allowed to cool.

The control valve between the two chambers was opened, and the temperature inside the refrigeration chamber was measured. Also, the temperature of the desiccant chamber was measured. In addition, approximately 100 simulated vials of medicine were placed in the cooler along with the refrigeration enclosure to simulate a payload of vaccines to be transported in this cooler.

The system was operated. The valve was opened, and the temperature of air in the refrigeration chamber lowered to 4° C. and the valve was closed. When the air temperature within the refrigeration chamber rose to 4.5° C., the valve was opened again, and the temperature was allowed to chill to 4° C. again. This was repeated 8 times over 450 minutes.

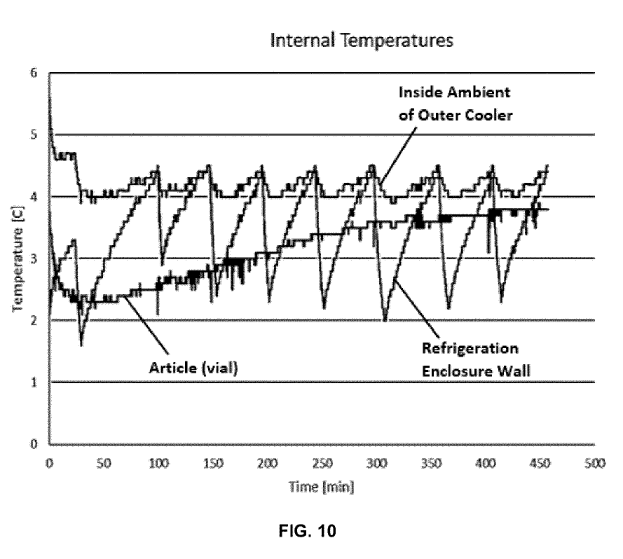

FIG. 10 shows the data from this test. Plotted are the wall temperature of the refrigeration enclosure, the temperature within the cooler, and the temperature of the vials. After this test, the desiccant chamber was removed from the system and weighed. The start weight of the desiccant was 3285.8 g. The final weight of the desiccant was 3306.0 g. The mass adsorbed was therefore 20.2 grams. The total cycles of opening was 8, and the total time of operation was 450 minutes. The mass of water used per cycle was 2.52 grams. The total number of cycles that is possible with an initial 250 grams of water is 99 cycles, with a total time between cycles of 56 minutes. The refrigeration apparatus of this test would therefore be capable of cycling for 3.85 days, and with 250 grams of initial charge of water, this refrigeration apparatus could maintain desired temperatures without any extra energy added for 4.125 days. With operation of a manual pump and the addition of water, extended periods of operation are possible.

While this disclosure describes and enables several examples of an apparatus and a method for maintaining an article at a temperature that is below the ambient air temperature, other examples and applications are contemplated. Accordingly, the invention is intended to embrace those alternatives, modifications, equivalents, and variations as fall within the broad scope of the appended claims. The technology disclosed and claimed herein may be available for licensing in specific fields of use by the assignee of record.

We claim:

1. A refrigeration apparatus, comprising:
a refrigeration enclosure comprising outer walls defining a hermetic interior refrigeration chamber and a porous graphitic foam insert within the chamber;
a desiccant enclosure comprising outer walls defining a hermetic interior desiccant chamber, and a desiccant within the desiccant chamber;
a fluid conduit making a fluid connection between the refrigeration chamber and the desiccant chamber;
a control valve for controlling the flow of a fluid through the fluid conduit.

2. The refrigeration apparatus of claim 1, further comprising an insulated outer cooler for receiving the refrigeration enclosure and the article.

3. The refrigeration apparatus of claim 1, wherein the porous thermally conductive foam insert comprises at least one selected from the group consisting of graphitic foam, aluminum foam and copper foam.

4. The refrigeration apparatus of claim 1, wherein the desiccant comprises a zeolite.

5. The refrigeration apparatus of claim 1, wherein the desiccant comprises activated carbon.

6. The refrigeration apparatus of claim 1, further comprising a liquid in the refrigeration chamber.

7. The refrigeration apparatus of claim 7, wherein the liquid is water.

8. The refrigeration apparatus of claim 1, wherein the porous thermally conductive foam insert defines an interior space for receiving an article to be refrigerated.

9. The refrigeration apparatus of claim 1, wherein in an initial state there is liquid in the refrigeration chamber, the desiccant chamber is evacuated to a pressure less than the surrounding ambient air pressure and less than the refrigeration chamber, and the control valve is in a closed position.

10. The refrigeration apparatus of claim 1, wherein the refrigeration enclosure comprises thermal insulation.

11. The refrigeration apparatus of claim 10, wherein the thermal insulation comprises at least one selected from the group consisting of double walls, ceramic microspheres, and insulating polymeric materials.

12. The refrigeration apparatus of claim 1, further comprising a temperature sensor for sensing a temperature within the refrigeration apparatus.

13. The refrigeration apparatus of claim 12, further comprising an actuator for operating the control valve.

14. The refrigeration apparatus of claim 13, wherein the temperature sensor generates a control signal, and the actuator operates the control valve responsive to the control signal.

15. The refrigeration apparatus of claim 1, further comprising a vacuum pump to evacuate gas from the desiccant chamber.

16. The refrigeration apparatus of claim 15, wherein the vacuum pump is a manually operated vacuum pump.

17. The refrigeration apparatus of claim 1, wherein the sealed gas pressure within the refrigeration chamber is maintained at between approximately 5.2 torr (mmHg) and 8.0 torr (mmHg).

18. The refrigeration apparatus of claim 1, further comprising a vacuum pressure gauge penetrating the enclosure for monitoring and displaying the pressure of the sealed air in the interior chamber.

19. The refrigeration apparatus of claim 1, wherein the thermal conductive foam insert comprises a graphitic foam, and the graphitic foam has a thermal conductivity of from 50 W/mK to 245 W/mK.

20. The refrigeration apparatus of claim 1, wherein the thermally conductive foam insert comprises a graphitic foam, and the graphitic foam has a density of from 0.38 g/cm³ to 0.93 g/cm³.

21. The refrigeration apparatus of claim 1, further comprising a purge valve in at least one selected from the group consisting of the refrigeration enclosure and the desiccant enclosure.

22. The refrigeration apparatus of claim 1, wherein the refrigeration enclosure comprises a closeable opening providing access to the refrigeration chamber.

23. The refrigeration apparatus of claim 22, comprising a purge valve in the closeable opening.

24. The refrigeration apparatus of claim 1, wherein the dessicant enclosure comprises a closeable opening.

25. The refrigeration apparatus of claim 24, further comprising a purge valve in the closeable opening.

26. A method of refrigerating an article, comprising the steps of:
providing a refrigeration apparatus, comprising:
a refrigeration enclosure comprising outer walls defining a hermetic interior refrigeration chamber, and a porous thermally conductive foam insert within the chamber;
a desiccant enclosure comprising outer walls defining a hermetic interior desiccant chamber, and a desiccant within the desiccant chamber;
a fluid conduit making a fluid connection between the first chamber and the second chamber; and,
a control valve for controlling the flow of fluid through the fluid conduit;
placing an article to be refrigerated in proximity to the refrigeration chamber, and with the control valve in the closed position;
placing a liquid in the refrigeration chamber, the liquid entering the pores of the porous foam insert;
evacuating gas from the desiccant chamber to a pressure below the vapor pressure of the liquid in the refrigeration chamber; and,
opening the control valve to permit the liquid to vaporize in the refrigeration chamber and to flow from the refrigeration chamber to the desiccant chamber, the heat of vaporization cooling the porous thermally conductive foam insert and the article in proximity to the refrigeration enclosure.

27. The method of claim 26, wherein the porous thermally conductive foam insert comprises at least one selected from the group consisting of a graphitic foam, a copper foam, and an aluminum foam.

28. The method of claim 26, further comprising the step of placing the refrigeration enclosure and the article within an outer thermally insulated cooler.

29. The method of claim 26, wherein the liquid is water.

30. The method of claim 26, further comprising the step of desorbing the liquid from the desiccant by heating and cooling the desiccant.

31. The method of claim 26, further comprising the step of purging gas from the desiccant chamber until the pressure in the desiccant chamber is below the vapor pressure of the liquid.

32. The method of claim 31, wherein the pressure in the desiccant chamber after purging is 1-50 millitorr.

33. The method of claim 26, further comprising the step of purging gases from the refrigeration chamber.

34. The method of claim 26, wherein the desiccant comprises at least on selected from the group consisting of a zeolite and activated carbon.

35. The method of claim 26, wherein the thermally conductive porous foam insert defines an interior space for receiving an article to be refrigerated, and further comprising the step of placing the article in the interior space of the porous thermally conductive foam insert.

36. The method of claim 26, further comprising the step of sensing a temperature within the refrigeration apparatus.

37. The method of claim 36, further comprising the step of operating the control valve responsive to the sensing of temperature.

38. The method of claim 37, further comprising the step of generating a temperature signal from the sensed temperature and operating an actuator for the control valve responsive to the sensed temperature.

39. The method of claim 26, further comprising the step of maintaining the sealed gas pressure within the refrigeration chamber at a pressure that is between 5.2 torr (mmHg) and 8.0 torr (mmHg) with a vacuum pump.

40. The method of claim 26, further comprising the step of monitoring a vacuum pressure within the refrigeration chamber, and operating the control valve responsive to the vacuum pressure.

41. The method of claim 26, wherein the gas is air.

42. A human-powered refrigeration system comprising:
a refrigeration enclosure comprising outer walls defining a hermetic interior refrigeration chamber, a porous thermally conductive foam insert and water within the chamber;
a desiccant enclosure comprising outer walls defining a hermetic interior desiccant chamber, and a desiccant within the desiccant chamber;
a fluid conduit making a fluid connection between the first chamber and the second chamber; and,
a control valve for controlling the flow of fluid through the fluid conduit;
a manual vacuum pump for reducing the pressure of the sealed air within the desiccant chamber; and
wherein the temperature of the insert is maintained at a temperature that is less than the temperature of the ambient air outside of the enclosure when a human activates the manual vacuum pump to reduce the pressure of the volume of sealed air within the desiccant chamber to a pressure that is below the vapor pressure of the water.
